(19) United States
(12) Patent Application Publication
(10) Pub. No.: US 2016/0090967 A1
(43) Pub. Date: Mar. 31, 2016

(54) WIND POWER GEARBOX

(71) Applicant: SIEMENS AKTIENGESELLSCHAFT, Munchen (DE)

(72) Inventors: Thomas Boland, Bocholt (DE); Dominikus Daners, Herten (DE)

(73) Assignee: SIEMENS AKTIENGESELLSCHAFT, Munchen (DE)

(21) Appl. No.: 14/867,841

(22) Filed: Sep. 28, 2015

(30) Foreign Application Priority Data
Sep. 29, 2014 (EP) 14186836.4

(51) Int. Cl. F03D 11/00; F03D 11/02

(52) U.S. Cl. CPC F03D 11/0008; F03D 11/02

(57) ABSTRACT

A wind power gearbox includes two oil chambers for receiving oil, each of the oil chambers having an opening to allow passage of oil. A pipe connects the two oil chambers to one another and has ends arranged in the openings of the chambers, respectively. The openings have each a conicity with an inner cone, which opens away from the oil chamber, with the ends of the pipe having a corresponding conicity with an outer cone. At least one static sealing element is arranged between the inner cone of the openings and the outer cone of the pipe ends for providing a seal.

### CROSS-REFERENCES TO RELATED APPLICATIONS

This application claims the priority of European Patent Application, Serial No. 14186836.4, filed Sep. 29, 2014, pursuant to 35 U.S.C. 119(a)-(d), the disclosure of which is incorporated herein by reference in its entirety as if fully set forth herein.

### BACKGROUND OF THE INVENTION

The present invention relates to a wind power gearbox.

The following discussion of related art is provided to assist the reader in understanding the advantages of the invention, and is not to be construed as an admission that this related art is prior art to this invention.

Wind power gearboxes, also referred to as WTG gearboxes, convert a wind-powered rotor rotation into a rotation of an electric generator (WTG=wind turbine generator). Multi-speed gearboxes are often used here. For instance, EP 2 199 607 B1 (Winergy AG) 23.06.2010 discloses a WTG gearbox having first and second planetary gear stages and a spur gearbox stage downstream of the planetary gearbox stage.

WTG gearboxes require adequate oil lubrication during operation. In order to receive the lubrication oil used for this purpose, a WTG gearbox comprises oil chambers, i.e. cavities filled at least partially with oil, which are disposed in vertically lower regions of the gearbox housing, since the lubrication oil accumulates there due to gravity. FIG. 1 shows a schematic representation of a side view of a WTG gearbox 1 having a first planetary gearbox stage 11, a second planetary gearbox stage 12 and a spur gearbox stage 13, wherein the dimensions measured at right angles to the gearbox axis A, e.g. the hollow wheel diameter, of the second planetary gearbox stage 12 are significantly smaller than the dimensions of the first planetary gearbox stage 11. The gearbox stages 11, 12, 13 successively convert a rotational speed and a torque of a rotor shaft 14 into a higher rotational speed and a lower torque of a generator shaft 15. The gearbox housing comprises sumps 16, 17 vertically below the first planetary gearbox stage 11 and the spur gearbox stage 13 in each instance, in which the oil used for lubrication during operation of the gearbox stages accumulates. Typical oil levels when the gearbox is stationary are indicated in FIG. 1 with a dashed line N16, N17. The two sumps 16, 17 are connected to one another by an unpressurized oil line 18 arranged on the exterior of the gearbox housing. In such cases the oil line 18 must be oil-tight and able to compensate for manufacturing tolerances of the interfaces, i.e. the connection points between the oil line 18 and the sumps 16, 17.

Previously such oil lines, which connect the two sumps of a WTG gearbox to one another, were generally either embodied as a flexible line or as a combination of a pipe with a pipe compensator. The disadvantage of a flexible line is in particular that the tubing material ages and its elasticity properties worsen, which may result in leaks.

FIG. 2 shows a sectional view of a conventional WTG gearbox, in which the oil line includes a pipe 28 and a pipe compensator 29, which each comprise a flange 281, 282 or 291, 292 at their axial ends. The flanges 281, 282 are preferably SAE flanges (SAE=Society of Automotive Engineers). The pipe 28 and the compensator 29 are connected to one another via a flange 281, 292 respectively. The pipe/compensator combination is connected to the connection points of the sumps 16, 17 by way of the other flanges 282, 291 in each instance. In such cases the compensator 29 is a flexible element for compensating for movements of the oil line, particularly with thermal changes in length, vibrations, wall bushings or settling processes. Tolerances are compensated here mechanically by way of an elastic bellows of the compensator 29. The disadvantage with a pipe/compensator combination is the large number of components and the relatively high investment costs.

It would therefore be desirable and advantageous to provide an improved wind power gearbox to obviate prior art shortcomings.

### SUMMARY OF THE INVENTION

According to one aspect of the present invention, a wind power gearbox includes two oil chambers for receiving oil, each of the oil chambers having an opening to allow passage of oil, a pipe connecting the two oil chambers to one another, the pipe configured to route oil and having ends arranged in the openings of the chambers, the openings having each a conicity with an inner cone, which opens away from the oil chamber, and the ends of the pipe having a corresponding conicity with an outer cone, and at least one static sealing element arranged between the inner cone of the openings and the outer cone of the pipe ends for providing a seal.

The oil chambers are oil containers, in particular cavities integrated into the gearbox housing for receiving oil, which is used to lubricate the gearbox. The openings of the oil chambers lead from the oil chambers outwards, i.e. into the vicinity of the gearbox. The connecting pipe thus runs outside of the gearbox housing. The two oil chambers can each be assigned to a gearbox stage, e.g. the first oil chamber to a planetary stage and the second oil chamber to a spur stage.

In accordance with the invention, the oil-tight connection of the two oil chambers is realized by a pipe, which is inserted into the two oil chambers by a clearance fit. Advantageously, the pipe can be axially fixed on both sides, i.e. on each of the two oil chambers, by a step on the pipe ends. Tolerances of the openings of the oil chambers can be compensated by a conicity of the fit. Sealing the pipe connection against unwanted escape of oil can be realized by one or more static seals, e.g. O-rings.

Due to a reduction in components being used and processing operations, the present invention results in a significant reduction in manufacturing costs compared with previously known approaches.

According to another advantageous feature of the present invention, at least one of the pipe ends can have a bevel on its outer periphery. As a result, insertion of the pipe end into the opening can, advantageously, be facilitated.

According to another advantageous feature of the present invention, at least one of the pipe ends can include a step for axial fixing of the pipe to the assigned one of the openings. This is advantageous because the pipe is prevented from sliding into the opening further than desired, so that an unwanted pinching of a sealing element is prevented for instance.

According to another advantageous feature of the present invention, the pipe can include a plurality of pipe parts, at least two of the pipe parts being displaceable axially relative to one another. Assembly and disassembly of the pipe on/from a WTG gearbox is facilitated as a result. Sealing of the at least two pipe parts which can be displaced axially relative to one another can be realized by a sealing element, e.g. an O-ring. The axial fixing of the at least two pipe parts which can be displaced axially relative to one another can be realized by a screw connection which runs radially, e.g. a grub screw.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a conventional wind power gearbox;

FIG. 2 is a sectional view of another conventional wind power gearbox;

FIG. 3 is a longitudinal section of a first embodiment of a pipe for routing oil in accordance with the present invention and intended for installation in a wind power gearbox;

FIG. 4 is a longitudinal section of the pipe of FIG. 3 with depiction of a radial shifting of the oil chambers; and

FIG. 5 is a longitudinal section of a second embodiment of a pipe for routing oil in accordance with the present invention and intended for installation in a wind power gearbox.

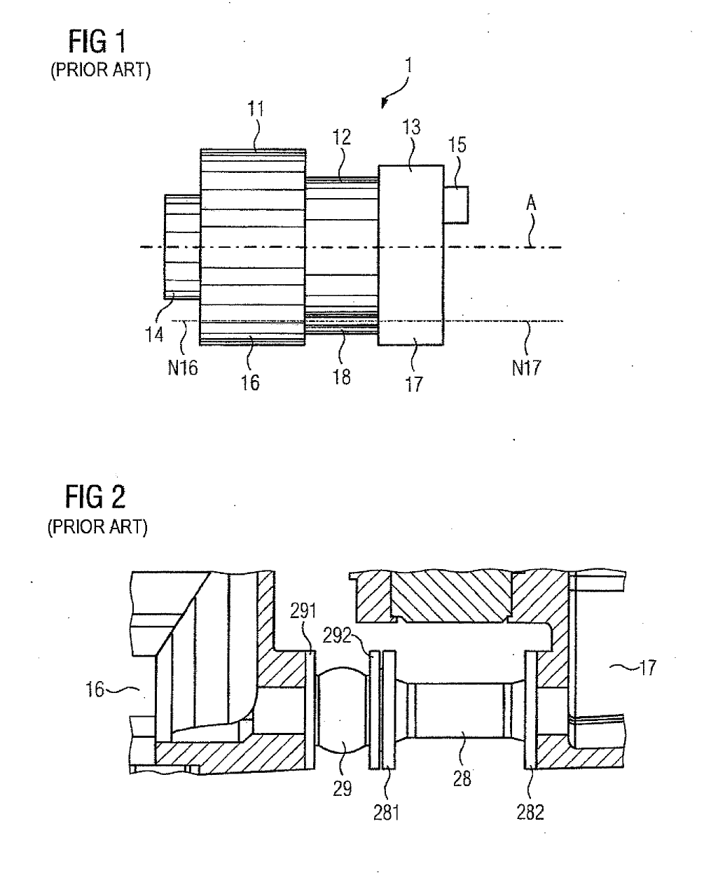

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

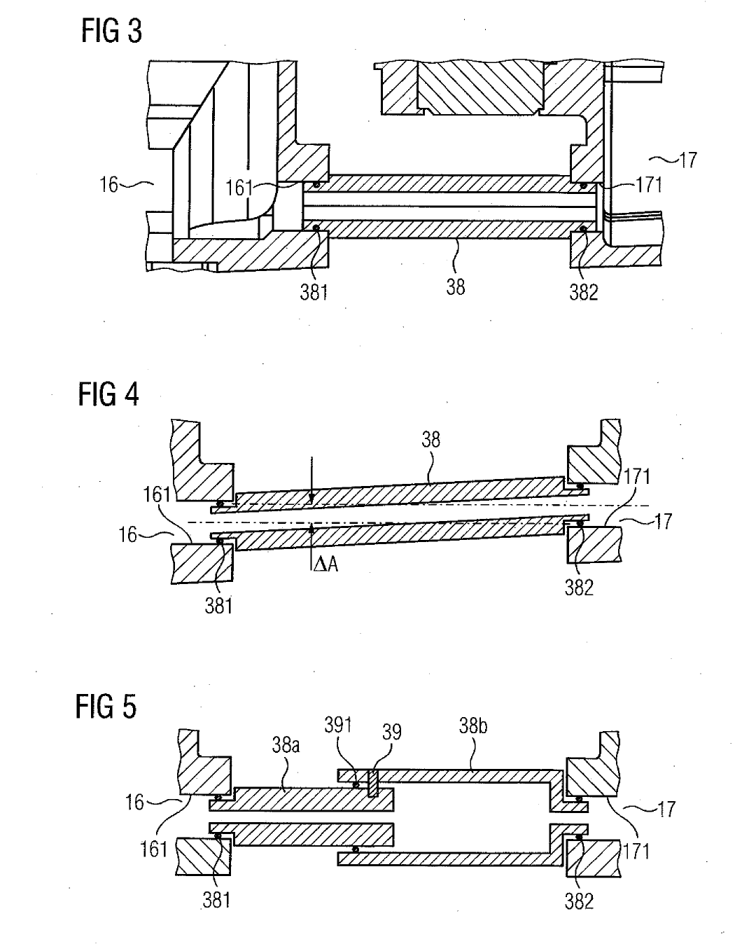

Turning now to the drawing, and in particular to FIG. 3, there is shown a longitudinal section of a first embodiment of a pipe for routing oil in accordance with the present invention, designated by reference numeral 38 for installation in a wind power gearbox. The pipe 38 is provided to connect two oil chambers 16, 17 of the WTG gearbox to one another, in order to enable an exchange of oil between the two oil chambers 16, 17 through the pipe 38.

Each of the oil chambers 16, 17 has a circular opening 161, 171, which is embodied by a borehole through the gearbox housing. The circular openings 161, 171 define central axes, which substantially extend horizontally and are ideally in alignment. Possible deviations can be compensated by the fits of the pipe 37 in the openings.

The pipe 38 is made, for example, of metal, e.g. steel. The pipe can however also be manufactured from other suitable materials such as plastic, e.g. fiber-glass-reinforced plastic. The pipe 38 can have a diameter which, currently preferred, is in the range of 50 to 300 mm, and a wall thickness which, currently preferred, is in the range of 10 to 100 mm.

The two ends of the pipe 38 are inserted into the two opposing openings 161, 171, respectively. For this purpose, the ends of the pipe 38 are provided with a diameter such that the ends inserted into the openings 161, 171 still have a certain play. As a result, a possible radial offset of the two oil chambers 16, 17, i.e. an axial offset ΔA of the two corresponding openings 161, 171, can be compensated by positioning the pipe 38 at an incline, as shown in FIG. 4.

Sealing elements 381, 382, here O-rings, are arranged between the inner surfaces of the openings 161, 171 and the outer surfaces of the pipe ends. Advantageously, the sealing elements 381, 383 are fixed to the outer surfaces of the pipe ends prior to insertion of the pipe into the openings 161, 171.

Assembly of the one-part pipe 38 in FIG. 3 into the WTG gearbox is realized by inserting the pipe 38 into the respective openings 161, 171, when the gearbox stages, such as gearbox stages 11, 12, 13, are connected. The pipe 38 can be replaced by detaching the spur stage 13 from the second planetary stage 12 and to slide it axially apart so that the pipe 38 can be moved out of the openings 161, 171.

FIG. 5 is a longitudinal section of a second embodiment of a pipe for routing oil in accordance with the present invention. Parts corresponding with those in FIG. 3 are denoted by identical reference numerals and not explained again. The description below will center on the differences between the embodiments. In this embodiment, provision is made for a two-part pipe 38 having a first pipe part 38a and a second pipe part 38b. The two pipe parts 38a, 38b are inserted with their one end into the two openings 161, 171. The two other ends of the pipe parts 38a, 38b, the so-called connecting ends, are pushed into one another in order to connect the two pipe parts 38a, 38b. The outer diameter of the connecting end of the first pipe part 38a and the inner diameter of the connecting end of the second pipe part 38b are hereby embodied such that the connecting end of the first pipe part 38a can be inserted into the connecting end of the second pipe part 38b. The connection has a slight radial play, so that a sealing ring 391 to seal the connection can be inserted between the outer diameter of the narrower pipe part 38a and the inner diameter of the further pipe part 38b.

In order to axially secure the two pipe parts 38a, 38b relative to one another, the two pipe parts 38a, 38b are connected by a screw 39, e.g. a grub screw, running radially through both pipe parts 38a, 38b. Axial and radial offset of the two oil chambers 16, 17 connected to one another by the pipe 38 compensated by way of the axial and radial play of the pipe parts 38a, 38b at the ends, with which the pipe parts 38a, 38b are inserted into the openings 161, 171 of the oil chambers 16, 17.

Assembly of the two-part pipe 38a, 38b in FIG. 5 into the WTG is realized by first moving the pipe parts 38a, 38b far into one another, then aligning them axially with the openings 161, 171 and moving the pipe parts 38a, 38b axially apart and simultaneously into the respective openings 161, 171. The axial position of the pipe parts 38a, 38b relative to one another is finally secured by the screw connection 39. As the length of the two-part pipe 38a, 38b can be changed, exchange of the pipe 38 thus no longer requires a detachment of the spur stage 13 from the second planetary, stage 12, and to slide the spur stage 13 and the second planetary stage 12 axially apart from one another. Instead, the pipe 38 can be replaced without disassembling the gearbox stages 12, 13.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A wind power gearbox, comprising:
two oil chambers for receiving oil, each of the oil chambers having an opening to allow passage of oil;
a pipe connecting the two oil chambers to one another, said pipe configured to route oil and having ends arranged in the openings of the chambers, said openings having each a conicity with an inner cone, which opens away from the oil chamber, said ends of the pipe having a corresponding conicity with an outer cone; and
at least one static sealing element arranged between the inner cone of the openings and the outer cone of the pipe ends for providing a seal.

2. The wind power gearbox of claim 1, wherein at least one of the pipe ends has a bevel.

3. The wind power gearbox of claim 1, wherein at least one of the pipe ends has a step for axial fixing of the pipe on the assigned one of the openings.

4. The wind power gearbox of claim 1, wherein the pipe includes a plurality of pipe parts, at least two of the pipe parts being displaceable axially relative to one another.
